(19) United States
(12) Patent Application Publication
(10) Pub. No.: US 2018/0291874 A1
(43) Pub. Date: Oct. 11, 2018

(54) Electronic Brake Controller for Wind Turbines

(71) Applicant: Sauer Energy, Inc., Oxnard, CA (US)

(72) Inventors: Dieter R. Sauer, JR., Oxnard, CA (US); James Michael Hubbard, Newbury Park, CA (US)

(73) Assignee: Sauer Energy, Inc., Oxnard, CA (US)

(21) Appl. No.: 15/485,157

(22) Filed: Apr. 11, 2017

(51) Int. Cl. F03D 7/02; F03D 17/00; F03D 7/04; F03D 9/00

(52) U.S. Cl. CPC F03D 7/0248; F03D 7/0276; F03D 9/007; F03D 7/042; F03D 17/00

(57) ABSTRACT

A brake for a wind turbine includes a disc coupled to and rotatable with the blade support hub of the turbine, and a piston and caliper assembly cooperating with the disc to stop or slow rotation of the blades. In one embodiment, the disc encircles and is rotatable about the shaft of the generator of a vertical axis wind turbine, with one piston and caliper assembly located on each side of the disc. The two piston and caliper assemblies are supported by a platform disposed above a vertical shaft that supports the blade support hub. In another embodiment, the piston and caliper assemblies are coupled to a platform at the end of the horizontally extending tail of a horizontal axis wind turbine.

### TECHNICAL FIELD

The present disclosure relates in general to turbines for converting wind energy into electrical energy and more particularly to an electronically controlled brake system for preventing wind turbine overspeed.

### BACKGROUND

Wind turbines are designed to produce power over a range of wind speeds. When wind speeds exceed the range for which a given wind turbine is designed, the rotational speed of the turbine blades needs to be reduced, or catastrophic failure can occur. There are several ways of doing this.

One strategy for reducing the speed of blade rotation is to change the pitch of the blades so that they stall or furl at high wind speeds. However, this is only possible with horizontal axis wind turbines, since the angle of vertical axis turbine blades is generally fixed. In addition, most pitch control systems are either electrically or hydraulically controlled, and cannot function if the electric grid breaks down or the hydraulic power fails. Furthermore, it not always possible to change the pitch of the blades quickly enough to stop rotation in response to sudden gusts of wind.

Another strategy for stopping or slowing blade rotation is to turn the blades away from the wind using a yaw controller Like pitch controllers, however, yaw controllers are only usable with horizontal axis wind turbines, are generally dependent on electrical or hydraulic power, and may take too long to respond to changes in wind speed. Furthermore, yaw controllers have numerous mechanical components, such as gears and bearings, that are subject to fatigue and failure.

Blade speed can also be lowered by reducing generator torque through an electromagnetic control system, but such a system becomes inoperable if the generator fails. The rotational speed of small wind turbines can be reduced with electrical brakes that dump energy from the generator into a resistor bank, converting the kinetic energy of the blade rotation into heat. However, electrical brakes are generally not suitable for large wind turbines.

Mechanical braking systems such as drum or disk brakes in combination with rotor locks are also sometimes used to stop turbines in emergency situations. However, because conventional brakes of this type can cause fires if applied when the turbine is rotating at full speed, they are typically only used after blade furling and electromagnetic controls have already slowed rotation to a safer speed. In addition, conventional mechanical brakes can be unreliable and may require frequent maintenance and/or service. Furthermore, disk brakes for high speed turbines require relatively large disc diameters that often cannot be accommodated in compact spaces.

These and other problems are addressed by this disclosure as summarized below.

### SUMMARY

In one aspect of the disclosure, a controller for preventing wind turbine overspeed includes a brake system, a sensor for monitoring an operation condition of the turbine, and a processor configured to receive signals from the sensor, to determine whether overspeed is imminent based on the signals, and to deploy the brake system when overspeed is imminent. In some embodiments, the sensor is a wind speed sensor, and the processor is configured deploy the brakes when the wind speed has reached a predetermined maximum wind speed value. In other embodiments, the sensor is an rpm meter, and the processor is configured to deploy the brakes when the wind turbine has reached a maximum rpm. In a preferred embodiment, the controller includes both a wind speed sensor and an rpm sensor, and the processor is configured to deploy the brakes if wither the maximum rpm or the maximum wind speed has been reached.

The processor may be energized by a power supply including a battery coupled to at least one solar panel. A voltage regulator configured to prevent overcharging may be coupled to the battery. A charge controller configured to block reverse current may be interposed between the solar panel in the battery. The battery may also be coupled to an external source in addition to the solar panel.

The brake system may include a dual caliper disc brake. In a preferred embodiment, the wind turbine includes a rotatable blade support hub, and the brake system comprises a disc coupled to and rotatable with the blade support hub, and at least one piston and caliper assembly cooperating with the disc to stop or slow rotation of the blade support hub. Each piston and caliper assembly includes a pair of brake shoes, a brake base, a lever pivotably coupled to the brake base and configured to assist in moving the brake shoes toward one another to clamp the disc therebetween, and a motorized linear actuator configured to pivot the lever. The processor is configured to energize the linear actuator or actuators when overspeed is imminent.

The system may include a wireless remote control unit configured to allow an operator to deploy the brakes from a distance. In addition, the system may include a manual actuator configured to allow an operator to deploy the brakes in the event of electrical failure.

### BRIEF DESCRIPTION OF THE DRAWINGS

FIG. 1A is a perspective view of a vertical axis wind turbine.

FIG. 1B is an enlarged view of detail 1B of FIG. 1A, with the front blade removed for purposes of clarity.

FIG. 2A is front view of the hub assembly of the vertical axis wind turbine of FIG. 1A.

FIG. 2B is a longitudinal sectional view of detail 2B of FIG. 2A.

FIG. 3 is an enlarged detailed view of a piston and caliper assembly and actuating assembly according to the present disclosure

FIG. 4A is a perspective view of a horizontal axis wind turbine, with the housing removed for purposes of clarity.

FIG. 4B is a fragmentary perspective view showing the blade support hub and braking assembly in the horizontal axis wind turbine of FIG. 4A.

FIG. 5 is a schematic diagram of the control circuit of the braking assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of the components. Therefore, specific structural and functional details disclosed herein are not to be interpreted as limiting, but merely as a representative basis for teaching one skilled in the art to variously employ the present invention.

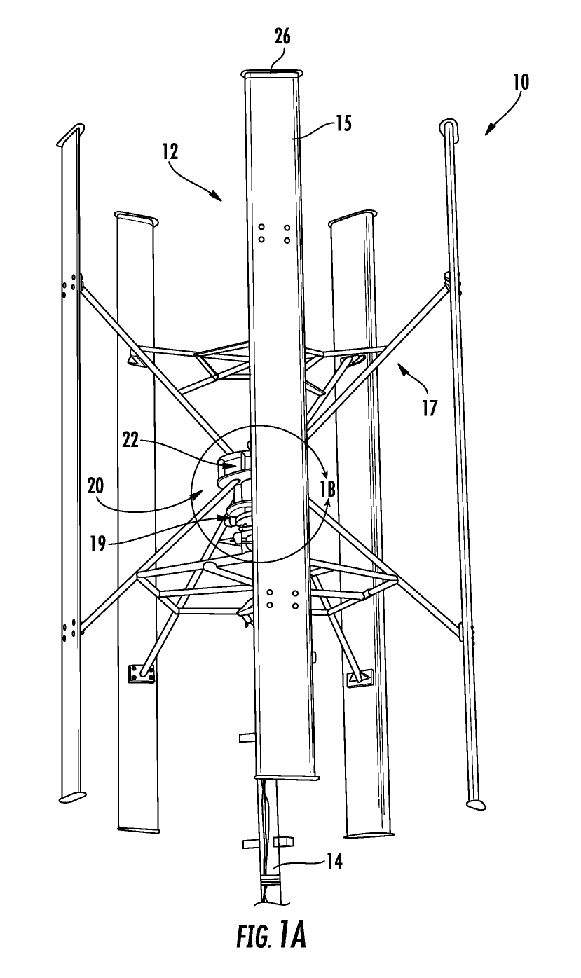

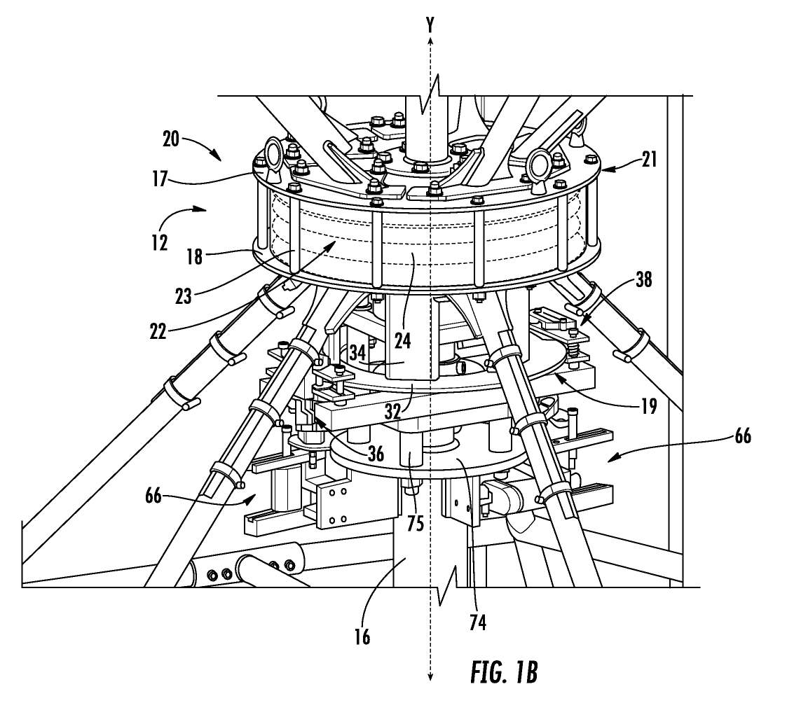

FIG. 1A shows a vertical axis wind turbine 10 including a blade assembly 12 mounted for rotation about a vertical tower or pole 14. The blade assembly 12 includes five substantially planar, vertically extending blades 15 and a generally hourglass-shaped frame 17 that stabilizes and supports the blades 15 as they rotate. Rotation of the blade assembly 12 causes rotation of a hub assembly 20 including a generator 22 that converts the kinetic energy of the blades 15 into electrical energy. A braking assembly 19 prevents the blade assembly 12 and hub assembly 20 from overspeeding.

The hub assembly 20, shown in FIG. 1B, comprises the generator 22, a blade support shaft 16, and the braking assembly 19. The generator 22 comprises a generator rotor 24 and a generator housing 21 including a pair of spaced apart circular plates 17, 18, that are coupled to one another by a set of vertically extending rods 23. Both the rotor 24 and the housing 21 are mounted for rotation about a vertical axis Y extending through the blade support shaft 16.

The braking assembly 19 includes an annular disc 32 that is suspended below the lower plate 18 of the blade support hub 14 by vertical bars 34. In this preferred embodiment, a first piston and caliper assembly 36 is provided on one side of the disc 32, and a second piston and caliper assembly 38 is provided on the other side of the disc 32. Each piston and caliper assembly 36 includes an actuating assembly 66 coupled to a circular support plate 74 that is suspended below the disc 32 by a set of columns 75. In less windy environments where less braking power is required, a single piston and caliper assembly may be used in lieu of the dual assembly shown here.

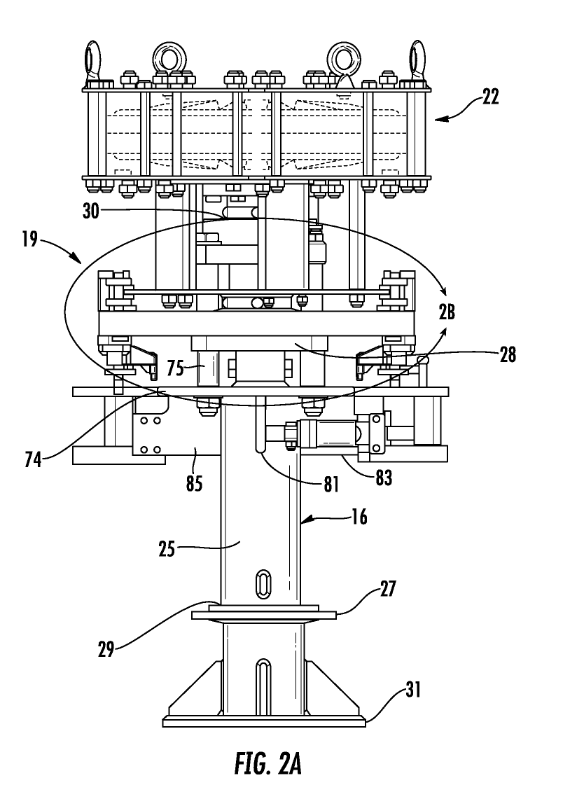

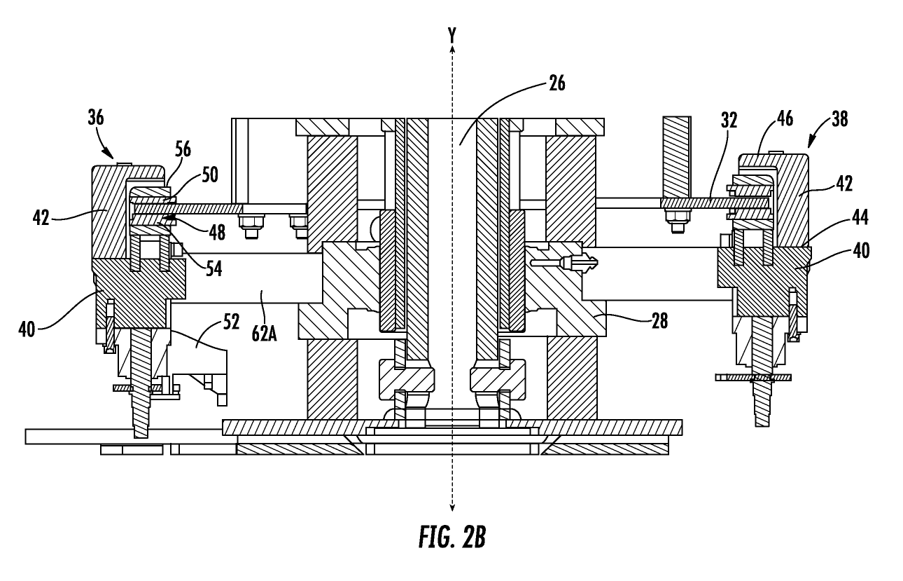

As best seen in FIG. 2A, the blade support shaft 16 includes a tubular intermediate portion 25 surrounded by a mounting ring 27 connected to the frame of the blade assembly. A first bearing 29, preferably a rolling element bearing formed from a high strength material such as steel, is interposed between the mounting ring 27 and the blade support shaft 16 to reduce friction between the ring 27 and the blade support shaft 16, as well as to transfer radial forces and bending moments from the blade assembly to the support shaft 16. A radially extending, circular mounting plate 31 at the lower end of the blade support shaft 16 is configured to connect the blade support shaft 16 to the tower. A circular platform 74 at the upper end of the blade support shaft 16 supports vertical columns 75, which carry second and third bearings 28, 30. The circular platform 74 is supported by a set of platform support flanges 81, 83, 85 that extend radially outwardly from the blade support shaft 16.

Details of the piston and caliper assemblies 36, 38 are shown in in FIG. 2B. Each piston and caliper assembly 36, 38 includes a brake base 40 and a caliper 42 having a first end 44 supported on the brake base 40 and an enlarged second end 46 opposite the first end 44. A first brake shoe 48 is provided between the first end 44 of the caliper 42 and the underside of the disc 32, and a second brake shoe 50 is provided between the second end 46 of the caliper 42 and the top of the disc 32.

The caliper 42 may be a commercially available caliper, such as a mechanical parking brake caliper of the type manufactured and sold as caliper number 120-12070 by Wilwood Engineering, Inc. of Camarillo, Calif. Another suitable type of disc brake caliper is shown and described in U.S. Pat. No. 6,422,354 B1 to Shaw et al. As the practitioner of ordinary skill is aware, these types of calipers include pistons that are acted upon by thrust pins or the like coupled to a lever 52 pivotably coupled to the brake base 40. When pivoted, the lever 52 drives the thrust pins and pistons towards the brake shoes 48, 50, which in turn are compressed against opposite sides of the disc 32, causing the disc 32, and therefore the generator rotor and the entire blade support hub, to slow or stop rotating about the generator shaft 26.

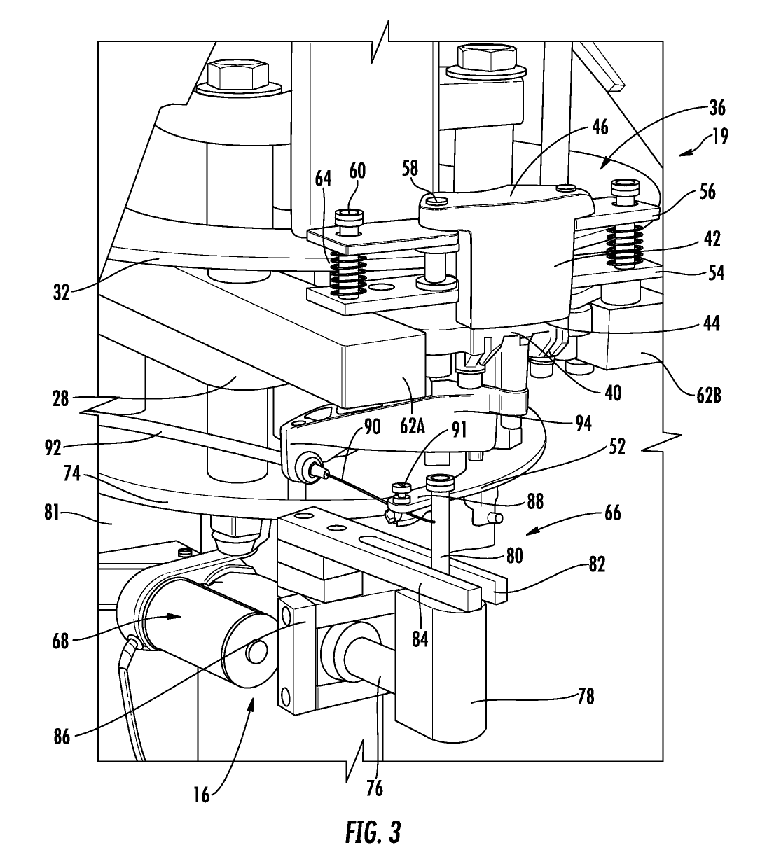

A first spacer bar 54 separates the first brake shoe 48 from the first end 44 of the caliper 42 and a second spacer bar 56 separates the second brake shoe 50 from the second end 46 of the caliper. As best shown in FIG. 3, the spacer bars 54, 56 are coupled to the caliper 42 by a pair of first fasteners 58. Each first fastener 58 may be, for example, a bolt that extends through aligned holes in the second end 46 of the caliper and the spacer bars 54, 56. A pair of second fasteners 60 secure the spacer bars 54, 56 to a platform comprising a pair of spaced apart platform bars 62A, 62B that extend along opposite sides of the generator shaft and are supported on top of the second bearing 28. Each second fastener 60 may be a bolt that extends through aligned holes in the spacer bars 54, 56, and the associated platform bar 62A or 62B. A central portion of the shank of each second fastener 60 may be surrounded by a spring 64 that urges spacer bars 54, 56 away from one another, ensuring that each brake 34, 36 can be quickly disengaged when necessary.

With continued reference to FIG. 3, the actuation assembly 66 for each piston and caliper assembly includes a motorized linear actuator 68 having a base 70 coupled to a first one of the platform support flanges 81. The linear actuator 68 includes a retractable arm 76 that moves in a direction parallel to the plane of the disc 74. An elongated pedestal 78 at the distal end of the arm 76 carries a driving rod 80 that extends perpendicularly to the arm 76, and pushes against the lever 52 when the arm 76 is retracted. The driving rod is carried within a channel 82 formed in a guiding arm 84 carried on a generally U-shaped support bracket 86 that encircles the retractable arm 76 and is coupled to a second one of the platform support flanges. The channel 82 and guiding arm 84 prevent or limit axial movement of the driving rod 78, ensuring that it moves in a substantially axial direction (ie. parallel to the axis of the longitudinal axis of the retractable arm 76) towards the lever 52.

A backup actuator is provided for pivoting the lever 52 when the motorized linear actuator 68 is inoperative, for instance during electrical power outages. The backup actuator comprises an elongated cable 90 having a first end secured to a pin 91 or other fastener at the free end 88 of the lever 52 and a second end accessible to an operator on the ground. The cable 90 is preferably encased within a protective sheath 92 and is held in place by a cable support arm 94 coupled to the brake base 40.

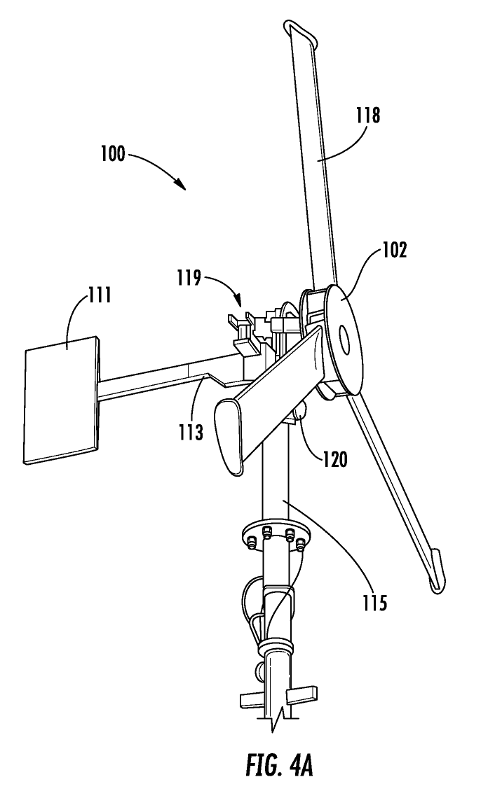

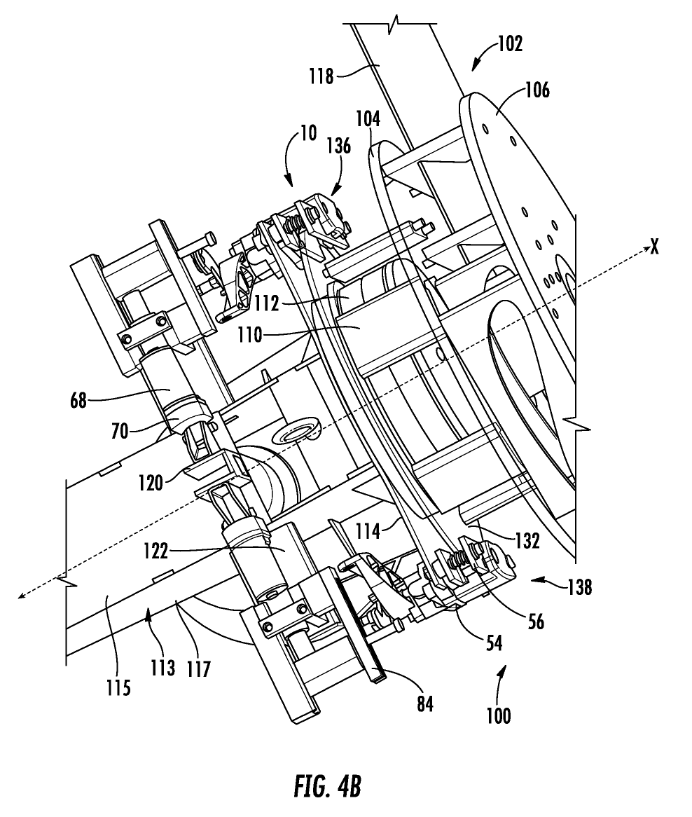

FIG. 4A shows a braking assembly 119 mounted in a horizontal axis wind turbine 100. The horizontal axis wind turbine 100 includes a plurality of blades 118 coupled to a blade mount 102 that rotates about a horizontal axis. A turbine mount 120 connects the blade mount 117 to a vertical tower or pole 115 and allows the turbine to rotate about the pole 115 in response to forces exerted by the wind on a yaw vane 111 mounted on an elongated tail 113 extending rearwardly of the blade mount 117. The rotation of the blade mount 117 about the pole 115 ensures that the blades 118 face into the wind for maximum output.

As shown in FIG. 4B, the blade mount 102 includes a pair of spaced apart face plates 104, 106 that symmetrically surround the wind turbine's horizontal axis of rotation X. An annular disc 132, identical in form and function to the annular disc 32 in FIGS. 1B, 2A, 2B, and 3, is coupled to the rear face plate 104 by vertical bars 110. The disc 108 and vertical bars 110 encircle a generator 112 that is supported on its rear side by a platform 114 secured to the front end of the tail 113. A first piston and caliper assembly 136 is provided on one side of the disc 132, and a second piston and caliper assembly 138 is provided on the other side of the disc 132. The piston and caliper assemblies 136, 138 are identical in form and function to the piston and caliper assemblies 136, 138 in FIGS. 1B, 2A, 2B, and 3, differing only in the way they are attached to the wind turbine 100. Specifically, the spacer plates 54, 56 are secured to the platform 114 at the rear side of the generator 112, while the base 70 of each motorized linear actuator 68 is supported by a bracket 120 projecting upwardly from an upper surface of the tail 113, and each guiding arm 84 is supported by a flange 122 extending laterally from a side surface of the tail 116.

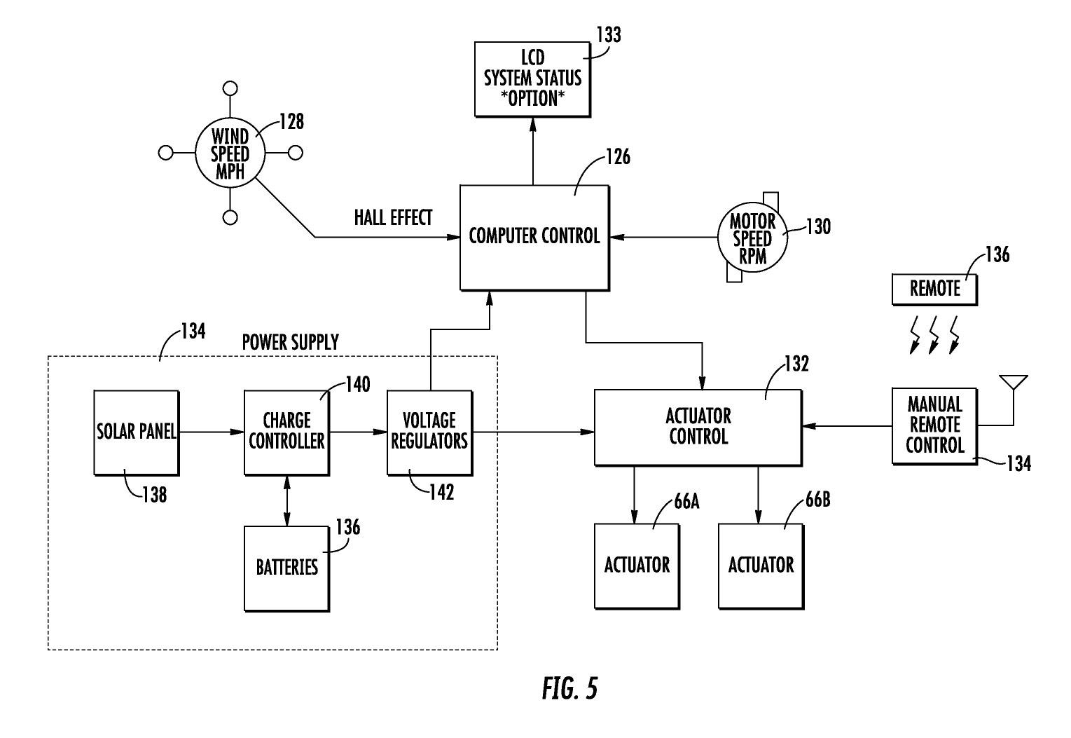

A control system for actuating the braking assembly 10, shown schematically in FIG. 5, includes a central processing unit or computer 126 electrically coupled to both a Hall Effect anemometer 128 or similar device for measuring wind speed and a motor RPM measuring device, such as a tachometer 130. The computer 126 receives input from the anemometer 128 and tachometer 130, and sends a signal to an actuator control unit 132 when it detects that either the wind speed or motor speed exceeds a preset value. Optionally, the computer may output system status information to an LCD display panel 133.

Upon detection of excessive wind or motor speeds, the actuator control unit 132 energizes the motorized linear actuator in one or both actuation assemblies 66A, 66B, causing the associated brake shoes to engage the disc, thus slowing or stopping rotation of the blade support assembly or, in the case of a horizontal axis wind turbine, the blade mount. If either the tachometer or the anemometer stops transmitting signals, indicating that one or both connections have been lost, the computer 126 is programmed to activate the actuation assemblies 66A, 66B, thereby stopping rotation of the blades until the connection or connections can be restored. Also, if the electrical system fails, the actuator control unit 132 can be activated through a handheld remote control 134 coupled to a wireless energy source 136.

Both the computer 126 and the actuator control unit 132 are powered by a power supply unit 134 comprising an array of batteries 136 that receive current from a solar panel 138. A charge controller 140 is interposed between the batteries 136 and the solar panel 138 to block reverse current, and a voltage regulator 142 is provided for preventing battery overcharge. Voltage information from the power supply is output to the computer 126, which shuts down the wind turbine 10 if the battery voltage is too low. In other embodiments, an external power source, such as an electrical outlet or a generator, is provided.

Referring again to FIG. 3, operation of a braking assembly 19 is as follows. When the control unit detects that either the wind speed or the rpm of the turbine has reached a maximum safe value, the motorized linear actuator 68 is energized, causing the retractable arm 76 and the elongated pedestal 78 to move inwardly toward the blade support shaft 16, until the driving rod 80 contacts the lever 52 secured to the brake base 40 of the caliper 42. This causes the lever 52 to pivot inwardly, which in turn causes the thrust pins and pistons inside the caliper to drive the brake shoes toward one another, clamping them against the disc 32. The frictional engagement between the brake shoes and the disc 32 slows and, eventually, stops rotation of the disc 32 and the blade support assembly.

Alternatively, if a power outage or other malfunction should prevent the motorized linear actuator 68 from drawing the retractable arm 76 against the lever 52, an operator may manually pivot the lever 52 by pulling cable 92.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A controller for preventing wind turbine overspeed, comprising
a brake system configured slow rotation of a wind turbine;
a sensor configured to monitor an operating condition of the wind turbine; and
a processor configured to
receive signals from the sensor,
determine whether overspeed is imminent based on the signals, and
deploy the brake system when overspeed is imminent.

2. The controller according to claim 1, wherein:
the sensor is a wind speed meter; and
the processor is configured to
determine whether the wind speed has reached a predetermined maximum wind speed value, and
deploy the brake system if the maximum wind speed value has been reached.

3. The controller according to claim 1, wherein:
the sensor is an rpm meter; and
the processor is configured to
determine whether the wind turbine has reached a predetermined maximum rpm value, and
deploy the brake system if the maximum rpm value has been reached.

4. The controller according to claim 1, wherein the sensor is a first sensor configured to monitor a first operating condition of the wind turbine, and further comprising:
a second sensor configured to monitor a second operating condition of the wind turbine;
wherein the processor is configured to
determine whether either the first operating condition or the second operating condition has reached a predetermined maximum acceptable value for that condition; and
deploy the brake system if the maximum acceptable value for that condition has been reached.

5. The controller according to claim 4, wherein:
the first sensor is a wind speed meter; and
the second sensor is an rpm meter.

6. The controller according to claim 5, further comprising a power supply configured to energize the processor, the power supply including:
a battery;
at least one solar panel coupled to the battery and configured to supply energy to the battery; and
a voltage regulator coupled to the battery and configured to prevent overcharging thereof.

7. The controller according to claim 6, wherein the battery is coupled to an external source in addition to the solar panel.

8. The controller according to claim 6, wherein the power supply further comprises a charge controller interposed between the solar panel and the battery and configured to block reverse current.

9. The controller according to claim 1, wherein the brake system comprises a dual caliper disc brake.

10. The controller according to claim 1, wherein the wind turbine includes a rotatable blade support hub, and the brake system comprises:
a disc coupled to and rotatable with the blade support hub; and
a piston and caliper assembly cooperating with the disc to stop or slow rotation of the blade support hub, the piston and caliper assembly including
a pair of brake shoes;
a brake base;
a lever pivotably coupled to the brake base and configured to assist in moving the brake shoes toward one another to clamp the disc therebetween; and
a motorized linear actuator configured to pivot the lever;
wherein the processor is configured to energize the motorized linear actuator when overspeed is imminent.

11. The controller according to claim 1, wherein the wind turbine includes a rotatable blade support hub, and the brake system comprises:
a disc coupled to and rotatable with the blade support hub; and
a pair of piston and caliper assemblies located on opposite sides of the disc and cooperating with the disc to stop or slow rotation of the blade support hub, each piston and caliper assembly including
a pair of brake shoes;
a brake base;
a lever pivotably coupled to the brake base and configured to assist in moving the brake shoes toward one another to clamp the disc therebetween; and
a motorized linear actuator configured to pivot the lever;
wherein the processor is configured to energize each motorized linear actuator independently of the other motorized linear actuator.

12. The controller according to claim 1, further comprising a wireless remote control unit configured to allow an operator to deploy the brakes from a distance.

13. The controller according to claim 1, further comprising a manual actuator configured to allow an operator to deploy the brakes in the event of electrical failure.

14. A controller for a wind turbine brake system, comprising:
a sensor configured to monitor an operating condition of the wind turbine; and
a processor configured to:
receive signals from the sensor,
determine whether overspeed is imminent based on the signals, and
deploy the brake system when overspeed is imminent.

15. The controller according to claim 14, wherein the sensor is a first sensor configured to monitor a first operating condition of the wind turbine, and further comprising:
a second sensor configured to monitor a second operating condition of the wind turbine; wherein the processor is configured to
determine whether either the first operating condition or the second operating condition has reached a predetermined maximum acceptable value for that condition; and
deploy the brake system if the maximum acceptable value for that condition has been reached.

16. The controller according to claim 15, wherein:
the first sensor is a wind speed meter; and
the second sensor is an rpm meter.

17. A controller for preventing overspeeding of a wind turbine having a rotatable blade support hub, comprising
a brake system configured to slow rotation of the blade support hub, the brake system including
a disc coupled to and rotatable with the blade support hub;
a pair of brake shoes;
a motorized linear actuator configured to move the brake shoes toward and away from the disc;
a sensor configured to monitor an operating condition of the wind turbine; and
a processor configured to
receive signals from the sensor,
determine whether overspeed is imminent based on the signals, and
energize the actuator to clamp the brake shoes against the disc when overspeed is imminent.

18. The controller according to claim 17, further comprising a power supply configured to energize the processor and the actuator, the power supply including:
a battery;
at least one solar panel coupled to the battery and configured to supply energy to the battery; and
a voltage regulator coupled to the battery and configured to prevent overcharging thereof.

19. The controller according to claim 17, wherein the sensor is a first sensor configured to monitor a first operating condition of the wind turbine, and further comprising:
a second sensor configured to monitor a second operating condition of the wind turbine;
wherein the processor is configured to
determine whether either the first operating condition or the second operating condition has reached a predetermined maximum acceptable value for that condition; and
deploy the brake system if the maximum acceptable value for that condition has been reached.

20. The controller according to claim 19, wherein:
the first sensor is a wind speed meter; and
the second sensor is an rpm meter.
